(19) United States
(12) Patent Application Publication
(10) Pub. No.: US 2017/0149776 A1
(43) Pub. Date: May 25, 2017

(54) METHOD FOR ONE-TO-ONE REGISTRATION BETWEEN PERSONAL AUTOMATION ID KIT AND SMARTPHONE

(71) Applicant: KOCOM CO., LTD., Bucheon-si, Gyeonggi-do (KR)

(72) Inventor: Jae-ho HYUN, Gimpo-si, Gyeonggi-do (KR)

(73) Assignee: KOCOM CO., LTD., Bucheon-si, Gyeonggi-do (KR)

(21) Appl. No.: 15/316,499

(22) PCT Filed: Jun. 3, 2015
(86) PCT No.: PCT/KR2015/005571

§ 371 Date: Jan. 12, 2017

(30) Foreign Application Priority Data
Jun. 3, 2014 (KR) 10-2014-0067672

(51) Int. Cl. H04L 29/06; H04W 12/06

(52) U.S. Cl. CPC H04L 63/0876; H04L 63/083; H04W 12/06

(57) ABSTRACT

A method for one-to-one registration between a personal automation ID kit and a smartphone comprises steps in which: a smartphone, which is a master, performs a pairing process for connection with an ID kit, which is a slave, and obtains an MAC address of the other; if the smartphone connects to an ID kit authentication server and clicks on a customer subscription menu, the ID kit authentication server authenticates the user of the smartphone via the connected smartphone; the smartphone receives customer information and transmits same to the ID kit authentication server; the smartphone transmits, to the ID kit authentication server, an MAC address and the ID kit MAC address; the ID kit authentication server registers the MAC addresses of the smartphone and ID kit in the MAC address DB if the ID kit MAC address is not a registered ID kit MAC address.

### TECHNICAL FIELD

The present invention relates to a method of one-to-one registration between a personal automation ID kit and a smartphone, and more particularly, to a method for registering one ID kit to only one smartphone to disable the ID kit to be used in another smartphone to which the ID kit is not registered.

### BACKGROUND ART

Recently, factory automation, office automation, and home automation, etc. are being achieved by automation in which a device or machine, etc. moves or works for itself without depending on a human.

Among them, the factory automation (FA) automates jobs in a factory using a computer, and aims not only to automate product manufacturing such as design, assembling, processing, and factory control for a product by machine including the computer or a robot, but also to rationalize a circulation system for an order, production, and supply, etc. where a factory, each department in a company, and related companies are connected by an information communication system.

The office automation (OA) automates jobs done in an office such as writing, storage, and delivery of a document using a computer or a facsimile.

The home automation (HA) attempts to create a pleasant living environment by furnishing electronic technology and a microcomputer to all aspects of home life, and aims not only for efficiency of home life such energy saving, but also for safety and convenience in such as crime prevention, visual communication, and home banking.

The factory automation means pure automation, the office automation means convenience, and home informatization means information and security.

On the other hand, out of such automation in a specific place, as a smartphone is diffused, it is anticipated that a personal automation age will arrive in the future.

This personal automation is automation in personal life or jobs, etc., and aims for automation proper to personal lifestyle or a situation in which an individual encounters.

Such personal automation is a concept of not only pure automation, convenience, information, and security, but also relief (safety) added to elementary concerns of humans.

For example, another meaning of the personal automation is to get out of minute concerns about robbery or loss of personal belongings such as an umbrella, shoes, a book, a handbag, diary, and a bag or losing a child, a pet dog, or a dotard, and to mellow out personal life.

For such personal automation, a device (hereinafter ‘ID kit’) has been developed and is in realization, which is attached to a personal belonging, an animal, or a person to interwork with a generally propagated smartphone.

At this point, after the ID kit and the smartphone undergo a pairing process, wireless communication, for example, Bluetooth communication is performed therebetween and in this case, when the ID kit and the smartphone are not in one-to-one registration, the ID kit is enabled to perform Bluetooth communication with another smartphone. At this point, when this ID kit is lost and robbed, another person may use this ID kit for personal automation.

In addition, when the ID kit is applied to a personal locker or a safe and one-to-one registration is not performed between the ID kit and the smartphone, since a door of the personal locker and safe may be opened through Bluetooth communication with the smartphone using the lost or robbed ID kit, it is concerned that personal belongings or valuables may be robbed.

### DISCLOSURE

### Technical Problem

The present invention provides a method for one-to-one registration between personal automation ID kit and smartphone in which one ID kit is registered to only one smartphone to disable another smartphone to which the one ID kit is not registered to perform wireless communication, for example, Bluetooth communication, which results that the ID kit is at less risk of robbery and even when the ID kit is lost or robbed, there is no concern about a secondary damage to make a user feel safe.

### Technical Solution

According to an embodiment of the present invention, a method for one-to-one registration between a personal automation ID kit and a smartphone includes: (a) performing a pairing process for connecting a smartphone as a master and a personal automation ID kit (hereinafter ‘ID kit’) as a slave to acquire MAC addresses of opposite parts;

(b) when an ID kit authentication server is accessed by the smartphone and a customer subscription menu is clicked, authenticating, by the ID kit authentication server, a user himself/herself of the corresponding smartphone through the smartphone accessing the ID kit authentication server;

(c) receiving, by the smartphone, customer information comprising login information (an ID and a password) and human information to transmit the customer information to the ID kit authentication server and performing subscription as a customer;

(d) transmitting, by the smartphone, the ID kit MAC address acquired in the pairing process and the MAC address of the smartphone itself to the ID kit authentication server;

(e) checking, by the ID kit authentication server, whether the ID kit MAC address is an ID kit MAC address pre-registered to an own MAC address DB; and

(f) when the ID kit MAC address is not the ID kit MAC address pre-registered to the ID kit authentication server, registering the MAC addresses of the smartphone and the ID kit to the MAC address DB.

According to another embodiment of the present invention, a method for one-to-one registration between a personal automation ID kit and a smartphone, the method comprising: (a′) performing a pairing process for connecting a smartphone as a master and an ID kit as a slave to acquire MAC addresses of opposite parts;

(b′) when an ID kit authentication server is accessed by the smartphone and a customer subscription menu is clicked, authenticating, by an ID kit authentication server, a user himself/herself of a corresponding smartphone through the smartphone accessing the ID kit authentication server;

(c′) receiving, by the smartphone, login information (an ID and a password) to transmit the login information to the ID kit authentication server;

(d′) authenticating, by the ID kit authentication server, the login information having been transmitted by the smartphone and providing, to the smartphone, an ID kit MAC address of a login customer pre-registered to an own MAC address DB;

(e′) comparing, by the smartphone, the ID kit MAC address acquired in the pairing process and a pre-registered ID kit MAC address provided by the ID kit authentication server and when the two ID kit MAC addresses are identical, transmitting, to the ID kit authentication server, a MAC address of a new smartphone; and

(f′) deleting, by the ID kit authentication server, an MAC address of a previous smartphone from the MAC address DB, changing to the MAC address of the new smartphone and registering the changed MAC address.

### Advantageous Effects

According to the technical solution, since one-to-one registration is performed between a personal automation ID kit and a smartphone, and one ID kit is registered to only one smartphone to disable another smartphone to which the one ID kit is not registered to perform wireless communication, for example, Bluetooth communication, the ID kit is at less risk of robbery and even when the ID kit is lost or robbed, there is no concern about a secondary damage to make a user feel safe.

In addition, since one ID kit is registered to only one smartphone by the one-to-one registration to be applied to a personal locker and a safe, and the door thereof may be unlocked by an authentication through the registered smartphone, safety of the personal locker or safe may be more strengthened.

### DESCRIPTION OF DRAWINGS

FIG. 1 is a configuration diagram of an ID kit according to an embodiment of the present invention.

FIG. 2 is a graph for explaining a function of the acceleration sensor illustrated in FIG. 1.

FIG. 3a and FIG. 3b are perspective views of appearance of the ID kit illustrated in FIG. 1.

FIG. 4a and FIG. 4b are views for explaining exemplary personal automation using the ID kit illustrated in FIG. 3.

FIG. 5 is a schematic diagram of a system for realizing a one-to-one registration method according to an embodiment of the present invention.

FIG. 6 is a flowchart of a one-to-one registration method according to an embodiment of the present invention.

FIG. 7 is a flowchart of a one-to-one registration method according to another embodiment of the present invention.

FIG. 8 is a flowchart for explaining an operation after one-to-one registration according to an embodiment of the present invention.

### BEST MODE

Herein, the same reference numerals are given to the same or corresponding elements, although they are illustrated in different drawings

In the following description, detailed descriptions of well-known functions or constructions will be omitted since they would obscure the invention in unnecessary detail.

In addition, when an element is referred to as “comprising” or “including” a component, it does not preclude another component but may further include the other component unless the context clearly indicates otherwise.

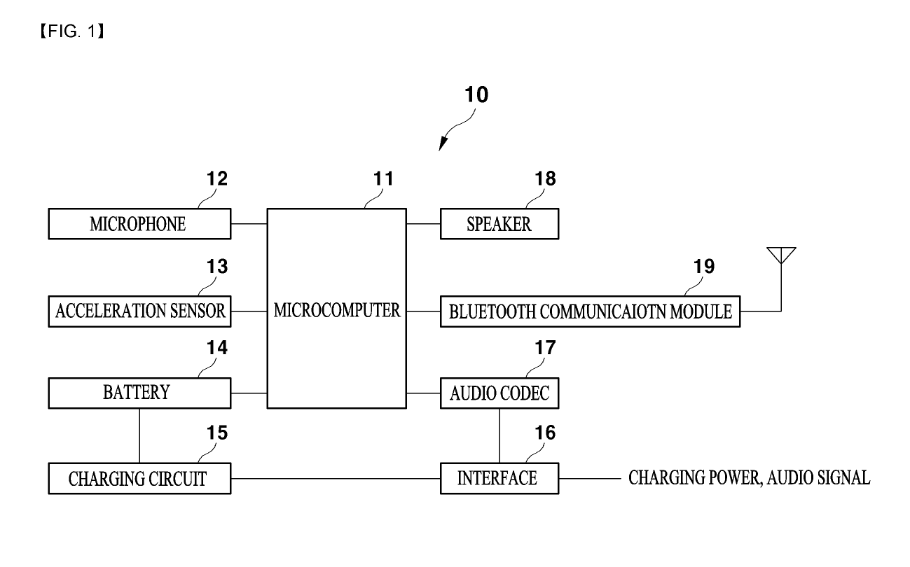

FIG. 1 is a configuration diagram of an ID kit according to an embodiment of the present invention.

As illustrated in FIG. 1, an ID kit 10 is basically provided with a microcomputer 11, a battery 14, and a Bluetooth communication module 19, and further provided with a microphone 12, an acceleration sensor 13, a charging circuit 15, a speaker 18, an audio codec 17, and an interface 16.

For the ID kit 10, a unique number is given to each ID kit and the unique number is registered to only one wireless communication device.

Here, the unique number is an MAC address allocated by a manufacturer at the time of manufacturing the ID kit.

Accordingly, since wireless communication is possible only with the corresponding smartphone and Bluetooth communication is not possible with all other smartphones that are not registered, this ID kit is not available to another person who takes it away.

The battery 14 supplies power to the microcomputer of the ID kit 10 and may be a secondary battery reusable by charging, and to this end, the charging circuit 15 is necessary.

The charging circuit 15 receives external power through the interface 16 and charges the battery 14 that is the secondary battery.

The Bluetooth communication module 19 is a component for performing, for example, Bluetooth communication with a smartphone, receives a signal of the smartphone to transfer the signal to the microcomputer, and transmits a signal from the microcomputer to the smartphone.

The microcomputer 11 operates according to an initially set program in using various input/outputs, receives a command from the smartphone through Bluetooth communication to perform an operation according to the command, and controls each component.

For example, the microcomputer executes a received command such as ‘Receive an analog signal and transmit the analog signal to a smartphone through a Bluetooth communication module’, ‘Read an acceleration sensor value and transmit the value, as it is, to the smartphone through the Bluetooth communication module’, ‘Convert a value received through the Bluetooth communication module to an analog signal and output the analog signal’, or ‘Convert a value received through the Bluetooth communication module to an analog signal and output the analog signal through the speaker’.

The microphone 12 receives an external analog audio signal, and a speaker outputs the analog audio signal externally.

The interface 16 receives charging power for charging the battery 14 from the outside, transmits an inside audio signal to an external device, and receives an audio signal from the external device to the inside. In other words, the interface 16 receives the charging power and inputs/outputs the audio signal.

The audio codec 17 converts an analog audio signal to a digital signal, while compressing data to perform encoding for use in communication, and on the contrary, converts a digital audio signal to an analog signal, while decompressing the compressed data to perform decoding.

For example, the audio codec 17 converts, to a digital signal, an analog audio signal received through the microphone 12 or through the interface and delivers the digital signal to the microcomputer 11, and converts, to an analog signal, a digital audio signal received through the Bluetooth communication module 19 and outputs the analog signal to the speaker 18.

The acceleration sensor 13 senses a change (movement) amount in 3-axis directions of X, Y, and Z and transmits the change amount to the microcomputer 11 through I2C communication.

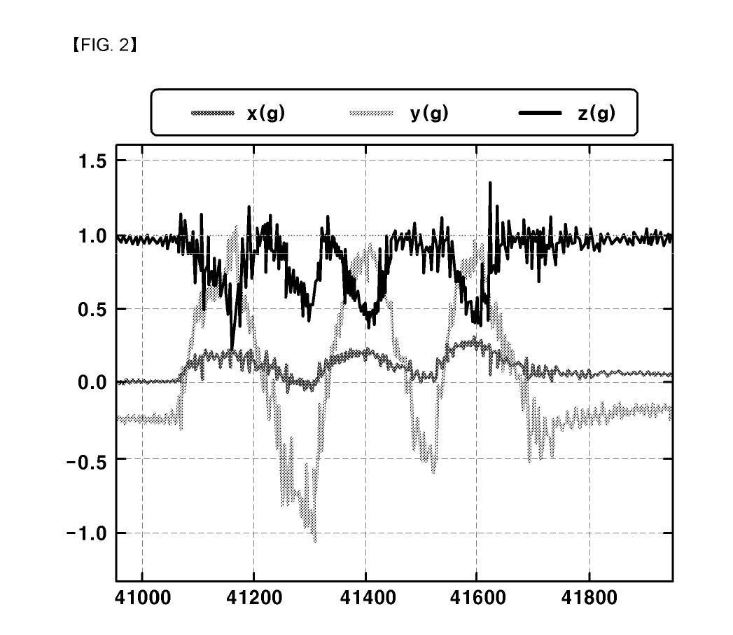

The change amount is a concept of coordinate values, and a movement change on each axis is digitized and continuously received, the digitized value being as shown in FIG. 2.

In FIG. 2, it may be known that there are movements three times identically in X and Y axis directions, but a more movement occurs in the Y-axis direction and a continuous movement occurs in the Z-axis direction.

A movement pattern may be known by checking such a flow change and when the ID kit 10 is attached to, for example, a shoe of a pedestrian, a movement pattern may be recognized at the time of walking, and walking posture may be corrected.

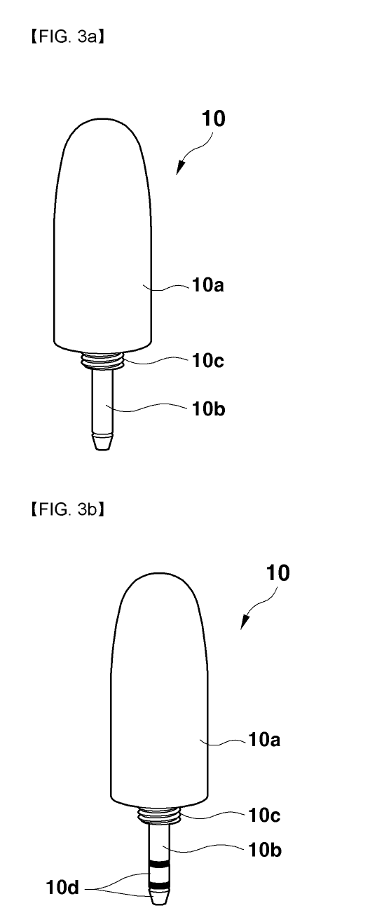

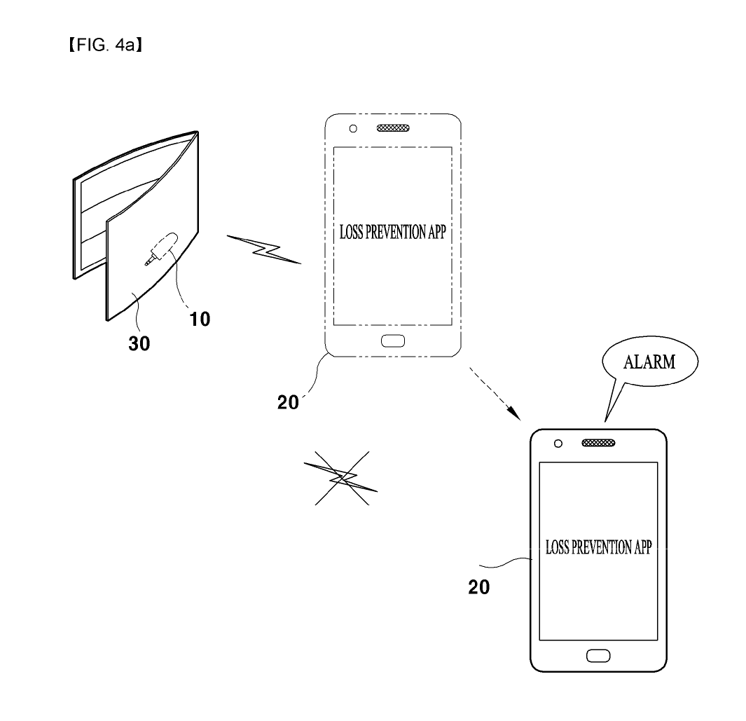

FIG. 3a and FIG. 3b are perspective views of appearance of the ID kit illustrated in FIG. 1.

As illustrated in FIG. 3a, in an embodiment, a terminal 10b protrudes from a kit main body 10a to form one body with the kit main body 10a and a male screw unit 10c is formed to have a larger diameter than the terminal 10b on an outer circumferential surface of the terminal adjacent to the kit main body 10a.

At this point, the microcomputer 11, the battery 14, and the Bluetooth communication module 19 from among the components illustrated in FIG. 1 are embedded in the kit main body 10a.

The kit main body 10a has a cylinder shape but an upper portion thereof is spherically rounded to facilitate insertion and the terminal 10b is formed to be one body with the kit main body 10a in a lower portion thereof.

As illustrated in FIG. 3b, in another embodiment, a terminal protruded from the kit main body to form one body with the kit main body 10a, the male screw unit 10c is formed to have a larger diameter than the terminal 10b on the outer circumferential surface of the terminal adjacent to the kit main body 10a, and an electrode 10d is formed for charging power and an audio signal on a terminal 10b therebelow.

At this point, the entire components illustrated in FIG. 1 are provided in the kit main body 10a and among them, a function of the interface 16 is realized by the terminal 10b on which the electrode 10d is formed.

The kit main body 10a has a cylinder shape but an upper portion thereof is spherically rounded to facilitate insertion and the terminal 10b is formed to be one body with the kit main body 10a in a lower portion thereof.

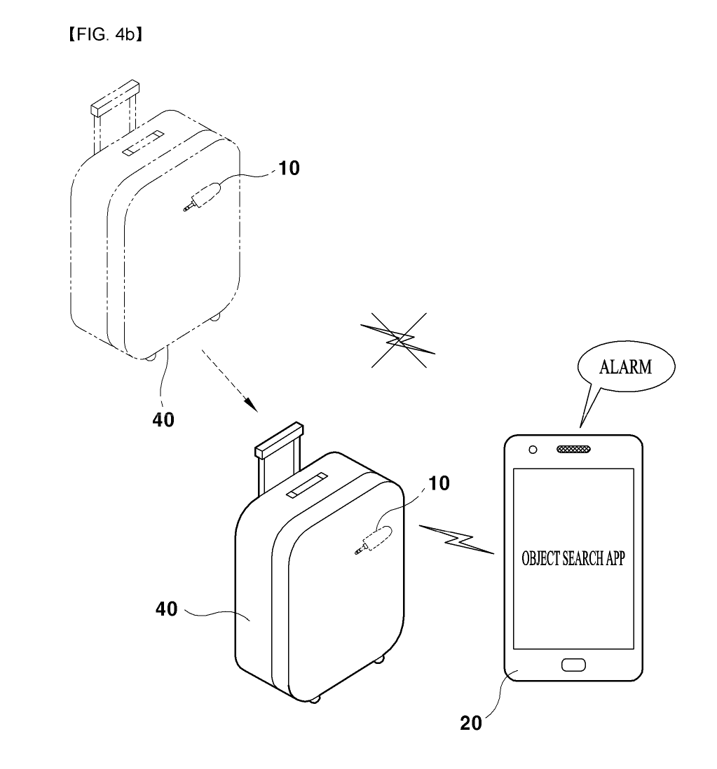

FIG. 4a and FIG. 4b are views for explaining exemplary personal automation using the ID kit illustrated in FIG. 3.

In FIG. 4a, a loss prevention app for alarming at the time when the Bluetooth communication is cut off from a specific ID kit 10 to which a unique number is given is installed in a smartphone 20 having a Bluetooth communication function, and when the corresponding specific kit 10 is attached to a personal belonging, for example, a wallet 30 and the smartphone 20 is close to the ID kit 10, the Bluetooth communication is enabled and the alarm does not ring in the smartphone 10.

When an owner of the smartphone 20 moves without carrying the wallet 20 and is a prescribed distance away from the ID kit, the Bluetooth communication between the ID kit 10 and the smartphone 20 is cut off and at this point, the alarm in the smartphone 20 rings.

Through this, the wallet owner may check that he/she does not carry the wallet 30.

In FIG. 4b, an object search app for alarming at the time when the Bluetooth communication is connected with a specific ID kit 10 to which a unique number is given is installed in a smartphone 20 having a Bluetooth communication function, and when the corresponding specific kit 10 is attached to, for example, a plane luggage 40, and the plane luggage 40 is loaded into the plane and is claimed by an owner of the plane luggage 40 after being unloaded from the plane, the Bluetooth communication is not possible at first and the alarm does not ring since the smartphone 20 is a distance away from the ID kit 10.

However, when the plane luggage 40 is carried on the carousel and close to the owner (i.e. smartphone) who desires to claim the luggage, the ID kit 10 and the smartphone 20 perform a pairing process and Bluetooth communication and at this point the alarm rings in the smartphone 20.

Through this, the luggage owner may know the luggage to be close to him/her and easily claim the luggage.

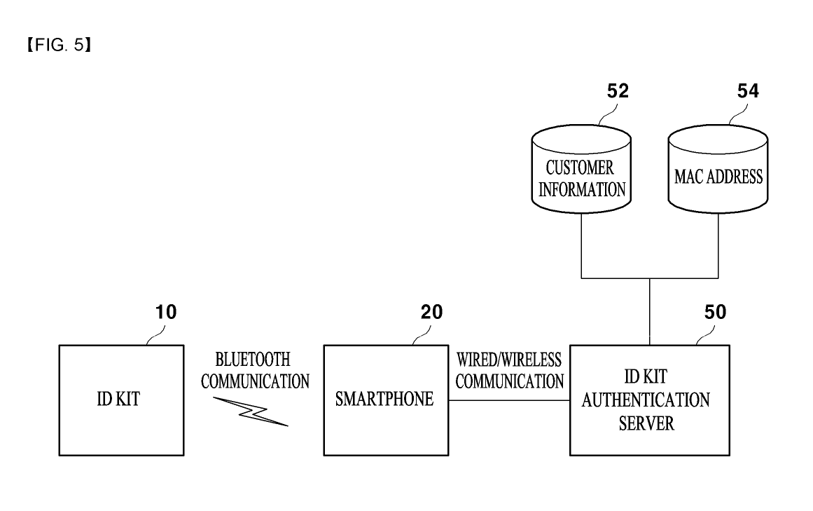

FIG. 5 is a schematic diagram of a system for realizing a one-to-one registration method according to an embodiment of the present invention.

As illustrated in FIG. 5, a system for realizing one-to-one registration method includes the ID kit 10, the smartphone 20, and an ID kit authentication server 50.

The smartphone 20 performs wireless communication, for example, Bluetooth communication, performs wired/wireless communication with the ID kit authentication server 50 to interwork with the ID kit authentication server 50, and registers a unique number of the ID kit 10 corresponding to a unique number of the smartphone 20 to the ID kit authentication server 50.

Here the unique numbers are respective Media Access Control (MAC) addresses of the smartphone 20 and the ID kit 10.

The MAC address is a unique identifier for enabling wireless connection and access to a network, and is not changeable, since it is allocated by a manufacturer at the time of manufacturing the smartphone 20 or the ID kit 10.

The smartphone 20 acquires the MAC address of the ID kit 10 in a process for performing Bluetooth pairing with the ID kit 10.

In addition, when a user wants to subscribe, as a customer, to the ID kit authentication server 50, the smartphone 20 accesses the ID kit authentication server 50 to confirm that the user is a user himself/herself of the smartphone, receives customer information such as login information (ID or password), and transmits the customer information to the ID kit authentication server 50 to enable subscription thereto as the customer, and at this point, the ID kit authentication server 50 registers the customer information to a customer information DB 52 and allows the user to subscribe as the customer.

After subscribing as the customer, when the user newly registers the smartphone 20 and the ID kit 10, the smartphone 20 reads the MAC addresses of the ID kit 10 and smartphone 20 to transmit the MAC addresses to the ID kit authentication server 50, and at this point, the ID kit authentication server 50 checks whether the MAC address of the ID kit transmitted from the smartphone 20 is a MAC address pre-registered to a MAC address DB 54, and when the MAC address of the ID kit is the pre-registered MAC address, the ID kit authentication server 50 does not newly register the MAC address of the ID kit to the MAC address DB 54 and does not allow double registration.

When the MAC address of the ID kit is not the pre-registered MA address, the ID kit authentication server 50 newly registers the MAC addresses of the ID kit and smartphone to the MAC address DB 54 and allows interworks with login information on a corresponding customer, which is stored in the customer information DB 52.

On the other hand, when the user changes his/her smartphone and wants to change and register a MAC address of the new smartphone 20 with the registration of the ID kit 10 maintained, the user accesses the ID kit authentication server 50 through the smartphone 20, confirms that the user is a user himself/herself of the smart and performs login.

After a login is performed, the ID kit authentication server 50 provides, to the smartphone 20, a MAC address corresponding to information having been input at the time of the login, and the smartphone 20 compares an ID kit MAC address acquired in the pairing process with the ID kit MAC address provided from the ID kit authentication server 50. When the two MAC addresses are matched with each other, the smartphone 20 transmits a MAC address of the new smartphone to enable the ID kit authentication server 50 to change to and register the new smartphone MAC address.

Here, when the ID kit MAC address acquired in the pairing process with the ID kit MAC address provided from the ID kit authentication server 50 do not match, the smartphone 20 determines the ID kit MAC address acquired in the pairing process as a MAC address of an ID kit possessed by another person and does not perform a procedure thereafter, in other words, does not transmit the smartphone's MAC address to the ID kit authentication server 50.

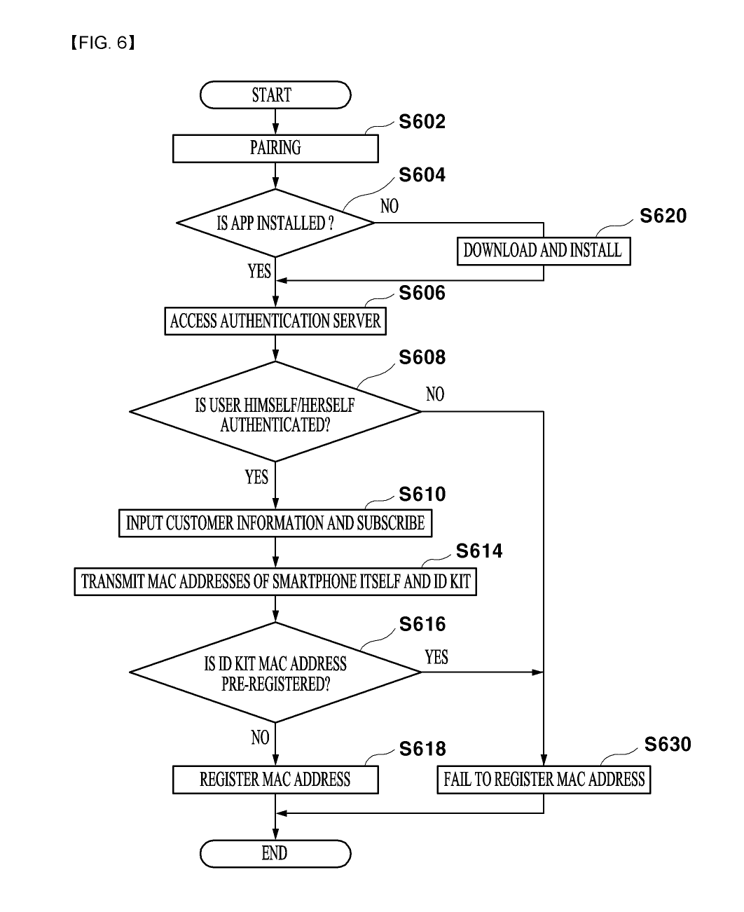

FIG. 6 is, as a flowchart of one-to-one registration method according to an embodiment of the present invention, a flowchart for a case where subscription is performed as a customer and new registration is performed on a smartphone and an ID kit.

Initially, for connection between the smartphone 20 as a master and the ID kit 10 as a slave, the smartphone 20 performs the pairing process by searching peripheral ID kits through an inquiry process to find an ID kit MAC address, exchanging PIN codes with each other using the found MAC address, and authenticating the ID kit (operation S602).

After the pairing process, the smartphone 20 checks whether an ID kit-related app (e.g. a loss prevention app of FIG. 4a or an object search app of FIG. 4b) is installed therein (operation S604), and when the ID kit-related app is not installed, the smartphone 20 downloads to install the ID kit-related app through an app store or the ID kit authentication server, etc. (operation S620).

When the ID kit-related app in the smartphone 20 is executed to access the ID kit authentication server 50 (operation 5606) and the user attempts to subscribe as a customer (in a case where a customer subscription menu is clicked), the ID kit authentication server 50 requests a name, a phone number, and a mobile communication company name, etc. from the user in order to authenticate the user to be a user himself/herself of the accessing smartphone 20, and when the name, the phone number, and the mobile communication company name, etc. are input, the ID kit authentication server 50 sends a user authentication text message including an authentication number to the phone number and authenticates the user himself/herself, when the authentication number included in the user authentication text message is input within a prescribed time (operation S608).

When the authentication number is not input within the prescribed time or another authentication number is input, the ID kit authentication server 50 determines the user not to be the user himself/herself and does not register the ID kit MAC address to the MAC address DB (operation S630).

After authenticating the smartphone user himself/herself, the smartphone 20 receives, from the user, customer information such as login information (ID and password) and human information to transmit the customer information and registers as a customer (operation S610).

Next, the smartphone 20 transmits, to the ID kit authentication server 50, the ID kit MAC address acquired in the pairing process and the MAC address of the smartphone itself (operation 614).

The ID kit authentication server 50 checks whether the received ID kit MAC address is an ID kit MAC address pre-registered to the MAC address DB 54 (operation S616), and when the received ID kit MAC address is not the pre-registered ID kit MAC address, the ID kit authentication server 50 stores the MAC addresses of the smartphone and ID kit in the MAC address DB 54 (operation S618).

When the received ID kit MAC address is the pre-registered ID kit MAC address, the ID kit authentication server 50 prevents double registration of the ID kit by stopping a post procedure and not storing the MAC addresses of the smartphone and the ID kit in the MAC address DB 54 (operation S630).

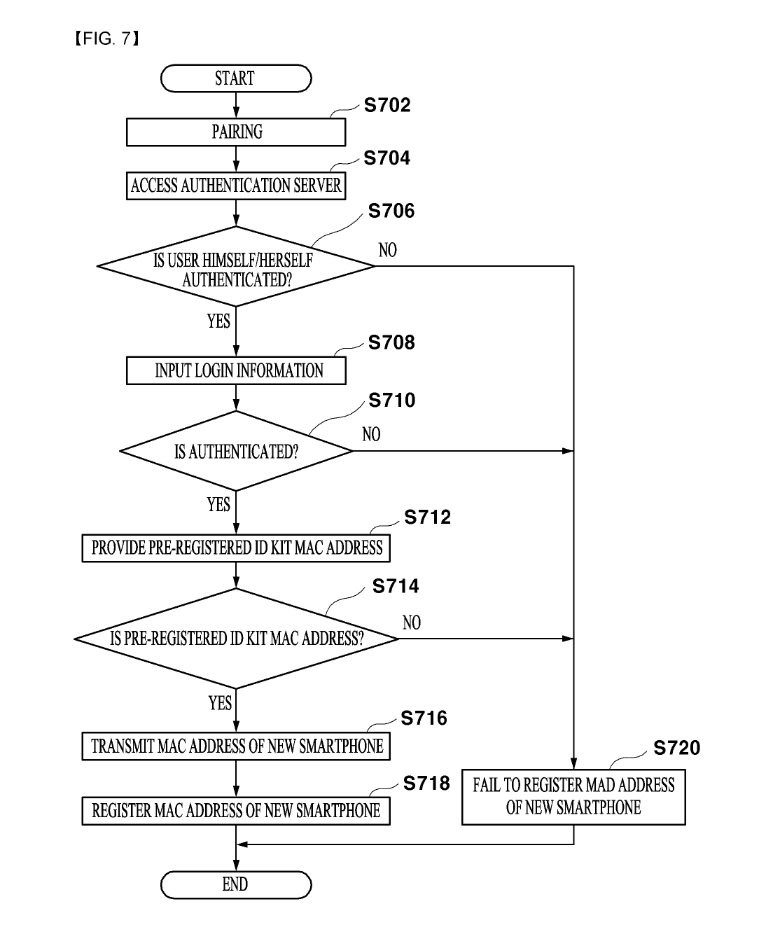

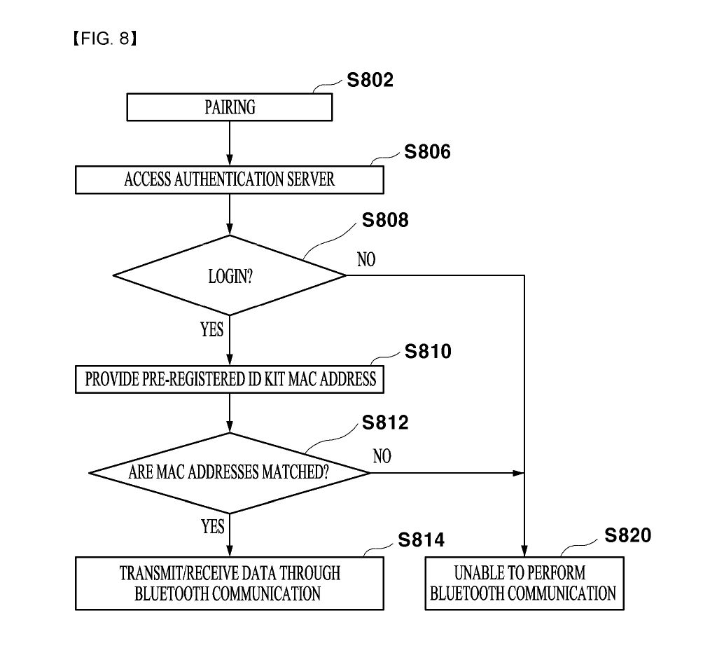

FIG. 7 is, as a flowchart for one-to-one registering method according to another embodiment of the present invention, a flowchart for changing only a smartphone to register the smartphone.

Initially, for connection between the smartphone 20 as a mater and the ID kit 10 as a slave, the smartphone 20 performs the pairing process by searching peripheral ID kits through an inquiry process to find an ID kit MAC address, exchanging PIN codes with each other using the found MAC address, and authenticating the ID kit (operation S702).

When the smartphone 10 accesses the ID kit authentication server (operation 704) and changes to register the smartphone (in a case where a smartphone change menu is clicked), the ID kit authentication server requests a name, a phone number, and a mobile communication company name, etc. from the user in order to authenticate a user himself/herself of the accessing smartphone 20, and when the name, the phone number, and the mobile communication company name, etc. is input, the ID kit authentication server 50 sends a user authentication text message including an authentication number to the phone number and authenticates the user himself/herself, when the authentication number included in the user authentication text message is input within a prescribed time (operation S706).

When the authentication number is not input within the prescribed time or another authentication number is input, the ID kit authentication server 50 determines the user not to be the user himself/herself, stops post processes, and does not register the an ID kit MAC address to the MAC address DB (operation S720).

After authenticating the smartphone as the user himself/herself, the smartphone 20 receives, from the user, login information (ID and password) to transmit the login information to the ID kit authentication server 50 (operation S708).

The ID kit authentication server 50 compares the login information transmitted from the smartphone 20 with login information stored in the customer information DB (operation S710), and when the two pieces of login information are identical, the ID kit authentication server 50 performs login authentication and provides, to the smartphone 20, the ID kit MAC address of a logged-in customer pre-registered to the MAC address DB 54 (operation S712).

The smartphone 20 compares the ID kit MAC address acquired in the pairing process with the pre-registered ID kit MAC address provided by the ID kit authentication server 50 (operation 5714) and when the two ID kit MAC address are identical (this means that a current ID kit of the customer is equal to a previous one), a MAC address of a new smartphone is transmitted to the ID kit authentication server 50 (operation S716).

Then the ID kit authentication server 50 deletes a MAC address of the previous smartphone from the MAC address DB 54, changes it to the MAC address of the new smartphone and registers the changed MAC address (operation S718).

When the ID kit MAC address acquired in the pairing process is different from the pre-registered ID kit MAC address provided by the ID kit authentication server 50 (this means the current ID kit is an ID kit of another person or an unregistered ID kit), a post registration procedure is stopped and it is not possible to register the MAC address of the smartphone to the MAC address DB (operation S720).

In addition, when the authentication fails in the login authentication operation S710, a post process procedure is stopped and it is not possible to register the MAC address of the smartphone to the MAC address DB (operation S720).

FIG. 8 is a flowchart for explaining an operation after one-to-one registration according to an embodiment of the present invention.

According to the sequences of FIGS. 6 and 7, in a state of the one-to-one registration between the smartphone 20 as the mater and the ID kit 10 as the slave, initially, for connection between the smartphone 20 as the mater and the ID kit 10 as the slave, the smartphone 20 performs the pairing process by searching peripheral ID kits through an inquiry process to find an ID kit MAC address, exchanging PIN codes with each other using the found MAC address, and authenticating the ID kit (operation S802).

After the pairing process, the smartphone 20 accesses the ID kit authentication server 50 (operation 5806) and performs the login authentication by inputting the login information such as the ID and password (operation S808), and when the login authentication succeeds, the ID kit authentication server 50 provides, to a corresponding smartphone, an ID kit MAC address of the login customer pre-registered to the MAC address DB (operation S810).

The smartphone 20 compares the ID kit MAC address acquired in the pairing process with the pre-registered ID kit MAC address provided from the ID kit authentication server 50 (operation S812), and when the two ID kit MAC addresses are identical, the smartphone 20 may begin Bluetooth communication with the corresponding ID kit (operation 5814) to perform a personal belonging loss prevention function as shown in FIG. 4a and an object search function as shown in FIG. 4b.

When the ID kit MAC address acquired in the pairing process is compared with the pre-registered ID kit MAC address provided from the ID kit authentication server and they are not identical, or when the login authentication fails, the Bluetooth communication with the ID kit 10 is not possible (operation S820), and the personal automation function as shown in FIG. 4a or FIG. 4b may not be performed.

Accordingly, although an ID kit 10 on which one person performs one-to-one registration with the smartphone 20 is held by another person, a personal automation function may not be performed using the ID kit 10, and when many people think about this, they do not think about robbing other people's ID kits 10 and a robbery risk may be further reduced.

Although the technical spirit of the present invention has been described with the accompanying drawings, it should be considered illustrative, and not restrictive. In addition, those skilled in the art will appreciate that various modifications, additions and substitutions are possible, without departing from the scope and the spirit of the invention as disclosed in the accompanying claims.

1. A method for one-to-one registration between a personal automation ID kit and a smartphone comprising:
(a) performing a pairing process for connecting a smartphone as a master and a personal automation ID kit (hereinafter ‘ID kit’) as a slave to acquire MAC addresses of opposite parts;
(b) when an ID kit authentication server is accessed by the smartphone and a customer subscription menu is clicked, authenticating, by the ID kit authentication server, a user himself/herself of the corresponding smartphone through the smartphone accessing the ID kit authentication server;
(c) receiving, by the smartphone, customer information comprising login information (an ID and a password) and human information to transmit the customer information to the ID kit authentication server and performing subscription as a customer;
(d) transmitting, by the smartphone, the ID kit MAC address acquired in the pairing process and the MAC address of the smartphone itself to the ID kit authentication server;
(e) checking, by the ID kit authentication server, whether the ID kit MAC address is an ID kit MAC address pre-registered to an own MAC address DB; and
(f) when the ID kit MAC address is not the ID kit MAC address pre-registered to the ID kit authentication server, registering the MAC addresses of the smartphone and the ID kit to the MAC address DB.

2. A method for one-to-one registration between a personal automation ID kit and a smartphone, the method comprising:
(a′) performing a pairing process for connecting a smartphone as a master and an ID kit as a slave to acquire MAC addresses of opposite parts;
(b′) when an ID kit authentication server is accessed by the smartphone and a customer subscription menu is clicked, authenticating, by an ID kit authentication server, a user himself/herself of a corresponding smartphone through the smartphone accessing the ID kit authentication server;
(c′) receiving, by the smartphone, login information (an ID and a password) to transmit the login information to the ID kit authentication server;
(d′) authenticating, by the ID kit authentication server, the login information having been transmitted by the smartphone and providing, to the smartphone, an ID kit MAC address of a login customer pre-registered to an own MAC address DB;
(e′) comparing, by the smartphone, the ID kit MAC address acquired in the pairing process and a pre-registered ID kit MAC address provided by the ID kit authentication server and when the two ID kit MAC addresses are identical, transmitting, to the ID kit authentication server, a MAC address of a new smartphone; and
(f′) deleting, by the ID kit authentication server, an MAC address of a previous smartphone from the MAC address DB, changing to the MAC address of the new smartphone and registering the changed MAC address.

3. The method for one-to-one registration between a personal automation ID kit and a smartphone according to claim 1, wherein in step (b), the ID kit authentication server sends a user authentication text message comprising an authentication number to a phone number having been input through the smartphone and when the authentication number comprised in the user authentication text message is input within a prescribed time, the ID kit authentication server authenticates the user himself/herself.

4. The method for one-to-one registration between a personal automation ID kit and a smartphone according to claim 1, wherein in step (a), the smartphone searches peripheral ID kits through an inquiry process for an ID kit, find a MAC address of the ID kit and then exchanges PIN codes with each other again using the found MAC address.

5. The method for one-to-one registration between a personal automation ID kit and a smartphone according to claim 1, wherein the ID kit and the smartphone perform Bluetooth communication.

6. The method for one-to-one registration between a personal automation ID kit and a smartphone according to claim 1, for using the ID kit for personal automation after step (f), further comprising:
(g) performing a pairing process for initially connecting the smartphone and the ID kit to acquire MAC addresses of opposite parts;
(h) accessing, by the smartphone, the ID kit authentication server and inputting the login information to perform login authentication;
(i) providing, by the ID kit authentication server, an ID kit MAC address of a login customer pre-registered to the own MAC address DB to the corresponding smartphone for which the login is authenticated; and
(j) comparing, by the smartphone, the ID kit MAC address acquired in the pairing process and a pre-registered ID kit MAC address provided by the ID kit authentication server, and when the two ID kit MAC addresses are identical, starting communication.

7. The method for one-to-one registration between a personal automation ID kit and a smartphone according to claim 2, wherein in step (b′), the ID kit authentication server sends a user authentication text message comprising an authentication number to a phone number having been input through the smartphone and when the authentication number comprised in the user authentication text message is input within a prescribed time, the ID kit authentication server authenticates the user himself/herself.

8. The method for one-to-one registration between a personal automation ID kit and a smartphone according to claim 2, wherein in step (a′), the smartphone searches peripheral ID kits through an inquiry process for an ID kit, find a MAC address of the ID kit and then exchanges PIN codes with each other again using the found MAC address.

9. The method for one-to-one registration between a personal automation ID kit and a smartphone according to claim 2, for using the ID kit for personal automation after step (f′), further comprising:
(g) performing a pairing process for initially connecting the smartphone and the ID kit to acquire MAC addresses of opposite parts;
(h) accessing, by the smartphone, the ID kit authentication server and inputting the login information to perform login authentication;
(i) providing, by the ID kit authentication server, an ID kit MAC address of a login customer pre-registered to the own MAC address DB to the corresponding smartphone for which the login is authenticated; and
(j) comparing, by the smartphone, the ID kit MAC address acquired in the pairing process and a pre-registered ID kit MAC address provided by the ID kit authentication server, and when the two ID kit MAC addresses are identical, starting communication.

10. The method for one-to-one registration between a personal automation ID kit and a smartphone according to claim 2, wherein the ID kit and the smartphone perform Bluetooth communication.
